(19) United States
(12) Patent Application Publication
(10) Pub. No.: US 2013/0211916 A1
(43) Pub. Date: Aug. 15, 2013

(54) AUTOMATIC REAL-TIME OPPORTUNITY-RELEVANT PROMOTIONS FOR AN AUTO BUYING ASSISTANT APPLICATION

(71) Applicant: John J. Putman, Lodi, WI (US)

(72) Inventor: John J. Putman, Lodi, WI (US)

(73) Assignee: CMFG Life Insurance Company, Madison, WI (US)

(21) Appl. No.: 13/370,068

(22) Filed: Feb. 9, 2012

(51) Int. Cl. G06Q 30/02

(52) U.S. Cl. 705/14.58

(57) ABSTRACT

Automatically receiving loan application promotions on a mobile device based on the mobile devices entering of a predetermined geographic area. The loan promotion application for the mobile device incorporates location-based promotion technology to provide financial institutions with the ability to deliver real-time opportunity-relevant loan promotions to potential borrowers based on the mobile device's physical presence at a point of sale.

### BACKGROUND OF THE INVENTION

1. Field of the Invention

This application relates generally to a loan promotion application, more particularly to a loan promotion application for automatically receiving loan application promotions on a mobile device based on that device's entering of a predetermined geographic area, and still more particularly to incorporating location-based promotion technology to provide financial institutions with the ability to deliver real-time opportunity-relevant loan promotions to potential borrowers based on a mobile phone's physical presence at a point of sale (i.e. next to a vehicle).

2. Description of the Related Art

Typically, when purchasing a vehicle at an auto-dealership, a buyer does not have the vehicle financing calculated and completed prior to a test drive and oral purchase agreement. Consequently, buyers are generally “in the dark” as to the cost per month for a specific vehicle as well as their loan approval status. Further, it is highly possible that after a buyer has chosen to purchase a vehicle they are forced to participate in a “back-room” signing ceremony with the auto-dealership's financing department and in turn lose the opportunity to finance through their financial institution. In addition to vehicle financing, there is no point of sale insurance method where the buyer can immediately receive a promotion for and execute the purchase of vehicle insurance.

### SUMMARY OF THE INVENTION

The present invention relates to a method for automatically receiving financing criteria by a mobile device including a location determination technology and a camera that comprises acquiring location information from the location determination technology; determining a presence of location conditions that include a physical residence of the mobile device within a zone; presenting a promotion and a set of information requests that include an applicant identification information request and an automobile identification information request if the presence of location conditions are determined; and presenting an updated promotion that is based upon a combination of the promotion, the applicant identification information, and the automobile identification information.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIG. 1 is a flow diagram illustrating an example of an auto buying assistant process;

FIGS. 2A-B are block diagrams illustrating examples of an auto buying assistant application;

FIGS. 3A-B are block diagrams illustrating examples of systems in which an auto buying assistant application operates;

FIG. 4 is a flow diagram illustrating an example of an auto buying assistant process; and

FIG. 5 is a flow diagram illustrating an example of an auto buying assistant process.

### DETAILED DESCRIPTION OF THE INVENTION

In the following description, for purposes of explanation, numerous details are set forth, such as flowcharts and system configurations, to provide an understanding of one or more embodiments. However, it is and will be apparent to one skilled in the art that these specific details are not required to practice the described invention.

In one embodiment, the present invention provides a multi-platform downloadable application for mobile devices that utilizes multi-zoning and location services to push real-time location-based promotions to a buyer while the buyer is at a vehicle contemplating their purchase. The multi-platform downloadable application utilizes the buyer's relative location to push both insurance and loan promotions to a mobile device, such as a phone, so that the buyer will know the potential cost while at the vehicle and contemplating its purchase.

Further, the multi-platform downloadable application may be an auto buying assistant application on a smartphone that accesses a loan website in conjunction with the GPS (global positioning system) function and camera function of the smartphone. For example, a smartphone auto buying assistant application receives at least a loan or insurance promotion when the smartphone with the auto buying assistant application installed thereon is located within an auto dealership or at the point of sale. Upon receipt of the promotion, the smartphone user may then snap a picture of (or scan) the vehicle identification number (VIN) behind the windshield and their personal identification card (ID) or driver's license. After this information is scanned, the auto buying assistant application decodes the VIN and ID to recalculate the promotions that were previously sent and displays new or enhanced offerings relative to the provided VIN and ID.

Because of the location-based promotion, the auto buying assistant application provides more information to the user regarding vehicle insurance and financing for a more informed purchasing decision prior to even identifying the vehicle. Thus, buyers can make immediate decisions as to whether they will purchase, finance, and insure the vehicle while standing in relative proximity. Further, the location based promotion may simultaneously be sent to the auto dealership, such that they may receive automatic and immediate confirmations (along with other information) to permit in expedited fashion vehicle purchasers (i.e. smartphone users) to drive out of the auto dealership in an insured and fully financed vehicle. This example transaction is expedited for at least the reason that the auto buying assistant application will circumvent the limited human ability to analyze and compute these complex transactions instantaneously. Furthermore, since there is no current method for an automatic loan and insurance promotion process, the described invention offers and details a fast way to provide real-time location-based promotions to the vehicle purchaser (i.e. smartphone user) without the need for additional post-purchase decision conversations and signing ceremonies. That is, in the above example, a buyer is never “in the dark” as to the cost per month for a specific vehicle, and the buyer is not forced to walk into the dealership building to commence a paper transaction. In addition, using the auto buying assistant application will both speed-up the process of vehicle purchases, provide financial institutions (i.e. credit unions) direct access to vehicle financing, and permit insurance companies to underwrite a policy before a vehicle is driven off the lot.

Furthermore, the auto buying assistant application can provide comparable product availability. That is, when smartphone users are at a vehicle and contemplating its purchase, the auto buying assistant application, based on their relative location to the dealership or vehicle or in response receiving a VIN, will search auto dealership inventory databases to discover similar vehicles located within a threshold distance from the smartphone user's current location and provide a notification of those vehicle and further applicable promotions.

A preferred way of implementing the above example is to receive a loan or insurance promotion using a mobile application installed on a smartphone for automatic receipt of financing criteria based on location conditions. However, a smartphone is not the only contemplated computer system. Any computer system, such as a laptop personal computer or a handheld portable computer (i.e., tablets, PDAs, cell phones, mobile phones, smart-phones, super-phones, etc.) may be implemented. Further, the functions described herein may be implemented on any conventional computing or electronic device, such as personal computer, conventional desktop computer, a network computer, or any of the various execution environments that will be readily apparent to the artisan and need not be named herein.

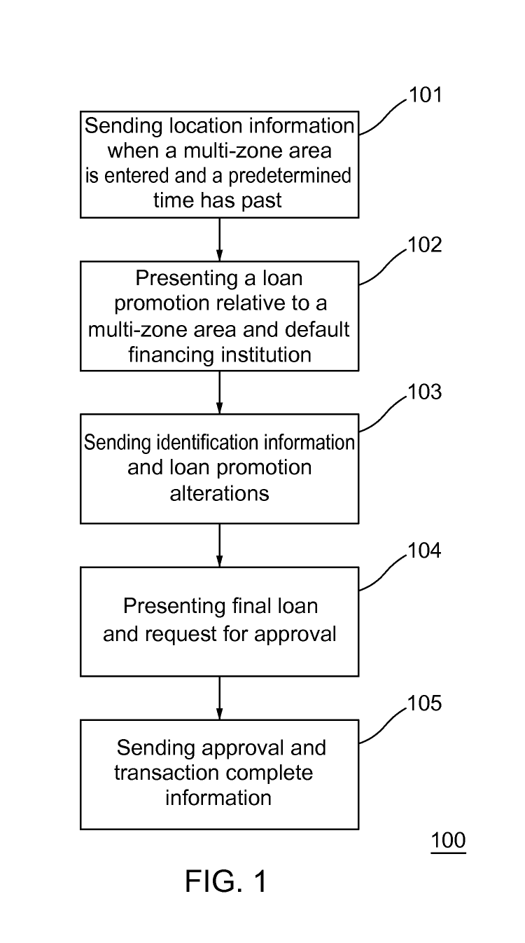

The computer system runs any conventional operating system through the interaction of the CPU (or GPU) and the memory to carry out the described functionality by execution of computer instructions. Operating systems may include but are not limited to iOS, Android, Windows, Unix, Linux, Macintosh, or the like. The computer system may further implement applications that facilitate calculations. The memory may be any memory suitable for storing data, such as any volatile or non-volatile memory, whether virtual or permanent, or any other non-transitory computer readable medium (i.e., compact disk, hard disk, etc.). Preferably, the memory stores the auto buying assistant application, which comprises program code that is executable by the processor to perform operations in support of supplying automatic promotions to the user. Therefore, the application is preferably provided as software on the computer system described above, yet it may alternatively be hardware, firmware, or any combination of software, hardware, and firmware. Still other embodiments include computer implemented processes described in connection with FIGS. 1-5.

The artisan will readily recognize the various alternative programming languages and execution platforms that are and will become available, and the described is not limited to any specific execution environment.

According to one aspect, the auto buying assistant application includes program code executable to perform operations for automatic receipt of financing criteria by a mobile device including a location determination technology and a camera, where location information generated by the location determination technology based on location conditions that include a physical location within a zone for a pre-determined time is sent to a server. The mobile device then receives a promotion and a set of information requests that include an applicant identification information request and an automobile identification information request. After replying to the set of information requests a loan application that is a combination of the promotion, the applicant identification information, and the automobile identification information is received by the mobile device. Receipt of the loan application by the auto buying assistant application permits the user with opportunity to confirm and trigger an automatic issuance of a loan.

However, to perform these functions a mobile device or phone should first acquire the auto buying application. Preferably, subscribing financial institutions provide downloadable forms of the auto buying assistant application through their own channels. In this case the default configurations may be based on the subscribing financial institution. Thus, when a user installs the auto buying application on his or her phone through a subscribing financial institution the default settings will automatically adjust to the credentials of the user's membership to the subscribing financial institution. In turn, promotions from the subscribing financial institution will receive priority over other promotions. An alternative acquisition method may be to utilize e-mails, where links initiate an automatic download of the auto buying assistant application or connect the smartphone user to the auto buying assistant application's location within an “App Marketplace” (such as, the Android and Apple app stores). Another alternative acquisition method may be to utilize postal mail, where letters contain a QR Code linking to the auto buying assistant application. In standard or non-financial institution provided downloadable versions, the default settings will be configured through a set of prompts upon the auto buying assistant application's initial boot. Regardless of how the users acquire the auto buying assistant application, they may be allowed to opt-out of location-based services to deactivate the automatic promotion features.

The automatic promotion features will now be described in further detail through the below examples. For example, the auto buying assistant application installed on a smartphone provides subscribing financial institutions the ability to deliver real-time opportunity-relevant loans to smartphone users (i.e. specifically to members and borrowers) based on the smartphone's location as determined by the location functions of the smartphone device. Correlating geographic areas with businesses may be addressed by the auto buying assistant application in a number of different ways. A first auto buying assistant application embodiment generates zones, such as by radiuses, around dealership locations or a GPS location, so that when the smartphone enters the radius and stays within that radius for a predetermined number of minutes, messages (i.e. promotions) are pushed to the auto buying assistant application from a server (or directly from a subscribing financial institution). Further, radii may be variably set by the auto buying assistant application. Alternatively, multi-zones may be generated whereby based on the smartphone's physical location within the radius described above, a more tailored promotion may be sent when sub-zones within said radiuses are penetrated. For instance, multi-zoning may be formed by defining a zone for each vehicle within the auto dealership. The use of satellite photos that are correlated with a GPS function may be used in constructing sub-zones. Furthermore, dealership's logs or inventory databases may be correlated with satellite photos or parking grids to identify the positions of each vehicle. In addition, radio frequency identification tags or a vehicle's navigational system may be used to generate the sub-zones. Using a multi-zone structure, the auto buying assistant application may decipher whether the smartphone is in an appropriate proximity to a pick-up truck or a hybrid, and due to any number of market variables adjusts the promotion accordingly. Alternatively, once the smartphone enters the radius around the dealership, as describe above, the smartphone may use near field communication (NFC) technology to identify when the smartphone is within a threshold proximity of any vehicle. Alternatively, vehicle navigation systems could be directly matched to the smartphone's location.

It should be noted that the battery-intensive nature of the GPS function of the phone may suggest that after activation, the app runs for a pre-determined time after which it deactivates to conserve battery life; however, the option to have the application constantly detecting whether the physical location is within a zone may be employed. Further, alternative location determination functions may be employed by the auto buying assistant application, such as network-based, handset-based, SIM-based, or any similar location determination technology that would be readily apparent to an artisan.

Regarding tailoring messages or promotions, messages can be specific to the smartphone user or the specific profile of the smartphone user's financial institution membership, such as a preapproval offer or a favorable interest rate based on the smartphone user's credit score. Promotions can also be generic, such as a market value loan, a general insurance estimate, or a generic loan based on the present interest rate. Further, messages may provide a link to a mobile web loan application or to the subscribing financial institutions web page to establish a direct connection at any point in the purchasing process. For example, a message may contain three lines indicating the subscribing financial institution name, a loan rate and down payment, and a link that directs the smartphone user to a page from loanliner.com (loanliner.com is website managed by CUNA mutual to deliver product and service solutions that meet the unique challenges and needs of financial institutions and their members).

Alternatively, automobile insurance providers may also add their information to provide the user with approximate insurance cost for a vehicle. Promotions may also contain loan complexity information with links that point to other sections of the auto buying assistant application. For instance, when a loan application has complex disclosure requirements the promotion may link directly to the tab or section of the auto buying assistant application that relates to completing those requirements. That is, prior to receiving promotion, users may enter their information under a disclosure tab and save that information for later use. Thus, the next time a complex loan application is linked to a promotion the user can avoid the time and energy of completing the disclosure requirements line by line. Promotions are also adaptable to the evolution of technology and legal requirements along with the accounting for the already present jurisdictional complications.

Promotions are generated by the auto buying assistant application for instant access to location-based deals; however, the auto buying assistant application may retrieve and update its maps through connections to external sources (i.e. a distributed or cloud computing system may also be employed when to share or access resources for generating promotions) such that the most current location-based deals are resident within the auto buying assistant application. This configuration permits the auto buying assistant application to operate without any external connection. For example, a smartphone user may directly prompt the auto buying assistant application using an override request or using NFC technology to swipe a vehicle's NFC tag to initiate the auto buying assistant application's services without an external location matching function.

The auto buying assistant application may also access the smartphone's integrated camera to scan encoded data, such as a VIN or smartphone user's ID. Thus, the auto buying assistant application has decoding capabilities built into the application to decode information regarding the vehicle based on the VIN and the user based on the ID. The situation is contemplated where a couple seeks to purchase a vehicle. Using one partner's smartphone, and subsequently the auto buying assistant application and account, that partner takes a picture of the other partner's driver's license after receiving a location-based promotion notifying the couple that a favorable interest rate is currently available through a subscribing financial institution. The application then decodes the driver's license through alphanumeric recognition technology to extract the other partner's name, address, date of birth, etc. Alternatively, the auto buying assistant application may scan the bar code on the back of driver's license. Either method would begin the automatic entry of data from the driver's license. At a minimum, name and address information, which may be manually entered or extracted from default configurations or pre-sets, would be required to respond to the promotion. Similarly, the one partner may take a picture of multiple VINs respective to each vehicle of interest. Alternatively, the preferred method for multiple vehicle identification would be through the location proximities, as described above. The auto buying assistant application would then use internal or pull external vehicle-specific history reports viewable on the mobile device (such as accident history, number of owners, odometer verification, and service history), along with financing information based directly on that VIN and insurance information based on the other partner's ID to update the promotion. In addition, the auto buying assistant application may use the VIN to determine the average retail price for the vehicle. The auto buying assistant application may further utilize the GPS of the smartphone to determine a ZIP code to account for regional price variances. Thus, the auto buying assistant application provides insurance and financing promotions based on location, on the vehicle information as determined by a VIN or vehicle radius, and on extracted driver's license information. Examples of an auto buying assistant application will now be given below.

FIG. 1 is a flow diagram illustrating an example of an automatic loan process. Specifically, FIG. 1 is a flow diagram illustrating an example of an automatic loan process 100, where when a mobile device enters a multi-zone area and after pre-determined time has past, the mobile device sends 101 location information to a server, financial institution, or insurance company. The mobile device either presents 102 a promotion that is relative to the multi-zone in which the mobile device has entered. The promotion may be further relative to the recipient of the location information (i.e. the server, financial institution, or insurance company). For instance, in the case where the auto buying assistant application has been downloaded directly from a subscribing financial institution, the default configuration as described above permits promotions directly relative to the subscribing financial institution. Further, if the location information is sent to an association that accumulates credit union memberships, then that association may respond with available promotions from any of its members that are able to underwrite a loan in the multi-zone area. Alternatively, the mobile device may trigger internal generation of the loan promotions based on the pre-determined location conditions regardless of whether the mobile device has a connection to an external network. In this case, the auto buying assistant application does not communicate with an external server to provide the promotion. In response to receiving a promotion, the mobile device sends 103 identification information and loan promotion alteration information to the server, financial institution, or insurance company. This allow the promotion to be updated or altered into a loan application that includes the sent identification information and other information, such as vehicle identification information and information relative to the multi-zone. Alternatively, the mobile device itself may use the identification information, vehicle identification information, and information relative to the multi-zone to internally alter the promotion or generate a loan application. The mobile device will then present 104 (or prompt the user with) the loan application and a request for approval (i.e. request for an electronic signature). Presumably a user wants to purchase the vehicle using the promotional loan and thus, the auto buying assistant application sends 105 approval confirmation and finalized transaction information to complete the purchase.

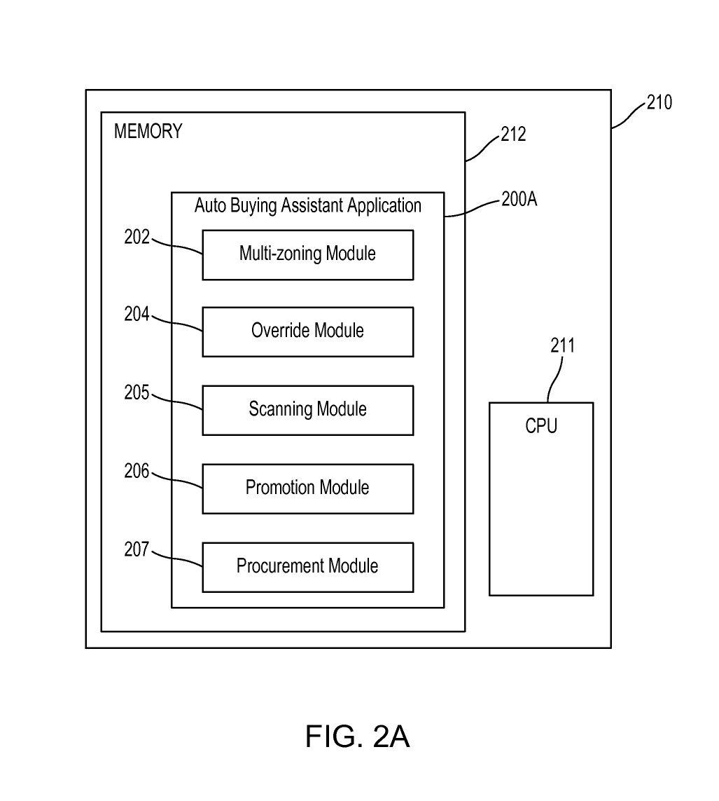

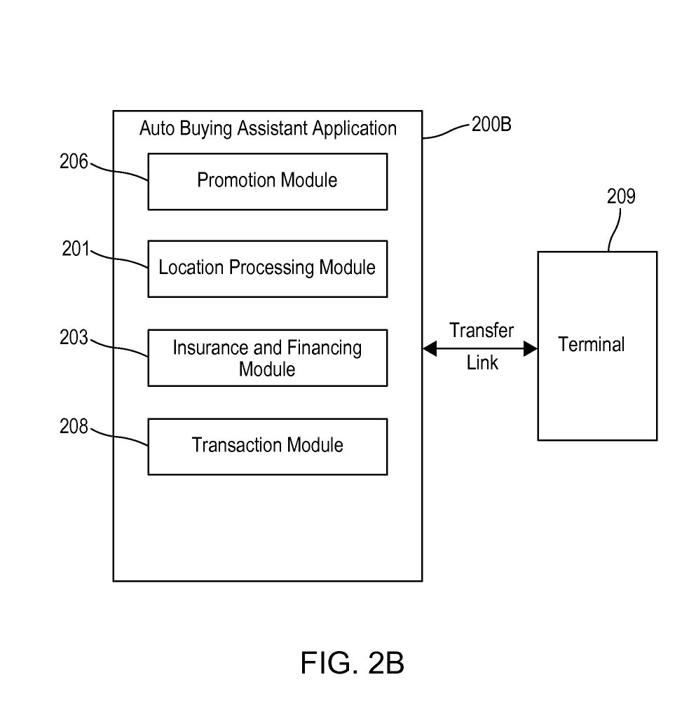

FIGS. 2A-B are block diagrams illustrating examples of an auto buying assistant application. Specifically, FIG. 2A is a block diagram illustrating an example of a mobile device 210 that comprises an auto buying assistant application 200A stored on a memory 212 and constructed from program code that is executable by a central processing unit (CPU) 211 to perform operations of providing real-time location-based promotions. Alternatively, the mobile device 210 may be any of the computer systems described above, and further the auto buying assistant application 200A may be implemented in any of the systems (350A and 350b) described below. Further, the auto buying application 200A is preferably provided as software, but may alternatively be provided as hardware or firmware, or any combination of software, hardware and/or firmware.

The application 200A is configured to provide automatic generation of location-based promotions, financing criteria, loan applications, and insurance promotions based on location conditions and time counters. Although one modular breakdown of the application 200A is offered, it should be understood that the same functionality may be provided using fewer, greater, or differently named modules. The example of the application 200A of FIG. 2A includes a multi-zone module 202, an override module 204, a scanning module 205, a promotion module 206, and a procurement module 207. And although it is not shown, the application 200A further includes a user interface module and an application programmable interface module; however, these modules may be integrated with any of the above named modules.

The multi-zone module 202 includes program code for presenting and identifying zones in which a physical presence of the mobile device 210 is detected. The presented loan application may be received following interaction with an external source, or may be locally generated, both as described above. The multi-zone module 202 further includes program code for correlating databases, image metadata, and location technology integrated into a mobile device 210 to effect calculation of the amount of time the mobile device 210 has been present in a zone. The multi-zone module 202 is capable of constructing both singular geographic zones and tiered zones. Further, the multi-zone 202 may construct these zones using the radial or other methods described above.

The override module 204 includes program code for receiving an override command that permits an automatic generation of a promotion by the mobile device or an automatic server request for promotional material. The override command may be defaulted to a button or latch external (not shown) to the mobile device 210, as well as any virtual touch screen button on the mobile device's display or a voice recognition command, such that when a user wants a promotion, the user may activate the override command to receive the promotion immediately.

The scanning module 205 is configured to apply decoding technology to any images taken by the mobile device's 210 integrated camera, along with any images stored in the memory 212. The scanning module 205 also applies metadata to VIN and ID scans for easy location determination.

The promotion module 206 includes program code for generating a loan or insurance promotion based on the location of the mobile device 210. The promotion module 206 further permits the user to alter timer and location configurations. For example, a user may want to adjust the length of time that the user has to wait before receiving an automatic notification that a favorable insurance rate relative to the vehicle that they are in proximity to is available.

The procurement module 207 is configured for completing a loan application or insurance purchase. The procurement module 207 implements subroutines that check that the information submitted by the user is valid, that the loan promotion from the financial institution is active and correctly applied, and connects the corresponding systems for loan approval. Similar subroutines are employed by the procurement module 207 when purchasing insurance.

The user interface module includes program code for managing the display and receipt of information from a user to provide the described functionality. The user interface module permits user management of the multi-zone qualifiers, input to the scanning module 205, control of the override module 204, and operating of the promotion and procurement modules (206 and 207). Further, the user interface module permits the auto buying assistant application to be displayed in a map, menu, icon, tabular, or grid format, with various functional representations according to a module's required functionality. That is, the user interface is configured to provide mapping and analytical tools that implement the auto buying assistant application's mapping features to display multi-zones and vehicle locations concurrently (and multi-zones to be selected using customizable interfaces). For example, mapping features include the capability to display the boundaries of an auto dealership and the vehicles within the auto dealership while offering visual depiction of zones bordering the auto dealership and relative to the vehicles. Additionally, a table or grid of data may concurrently be displayable so that the list of vehicles or relative promotions and advertisements can be manipulated, with the indicators on the map image updating accordingly. The grid/table view allows the user to sort the list of promotions based on total amount, interest rate, term, or any other dimensions. Additionally, the rows in the table are connected to the full database entry as well as the sale history for the respective vehicles. Combined with the map view, this allows for a convenient yet comprehensive interactive analysis of vehicle purchases.

The application programmable interface module is configured to communicate directly with other applications, modules, models, devices, and other sources through both physical and virtual interfaces. The application programmable interface module manages the dispatching and receipt of information in relation to the above sources and sources external to the application along with integrating the auto buying assistant application with other applications and drivers, as needed per operating system.

In another embodiment, FIG. 2B is a block diagram illustrating an example of an auto buying assistant application 200B that is external to a terminal 209, which accesses the functionality of the auto buying assistant application 200B. That is, a user device or smartphone may act as a terminal 209 where through either web browsing or mobile application technology the auto buying assistant applications are configured to run in the context of a server or host functionality. Further, the auto buying assistant application 200B of FIG. 2B at least includes a location processing module 201, an insurance and financing module 203, and a transaction module 208. Furthermore, the auto buying assistant application 200B may include any of the other modules listed in FIG. 2A. Again, it should be understood that the same functionality may be provided using fewer, greater, or differently named modules.

In FIG. 2B, the location processing module 201 includes program code for calculating and deciphering the specific location of the terminal 209. The location processing module 201 may work in connection with the multi-zone module 202 to determine proximity to the point of sale, as detailed above. The insurance and financing module 203 includes program code for compiling the jurisdictional differences regarding local market values and laws and applying them to the promotions offered by the promotional module 206, so that the promotions are legally valid when displayed.

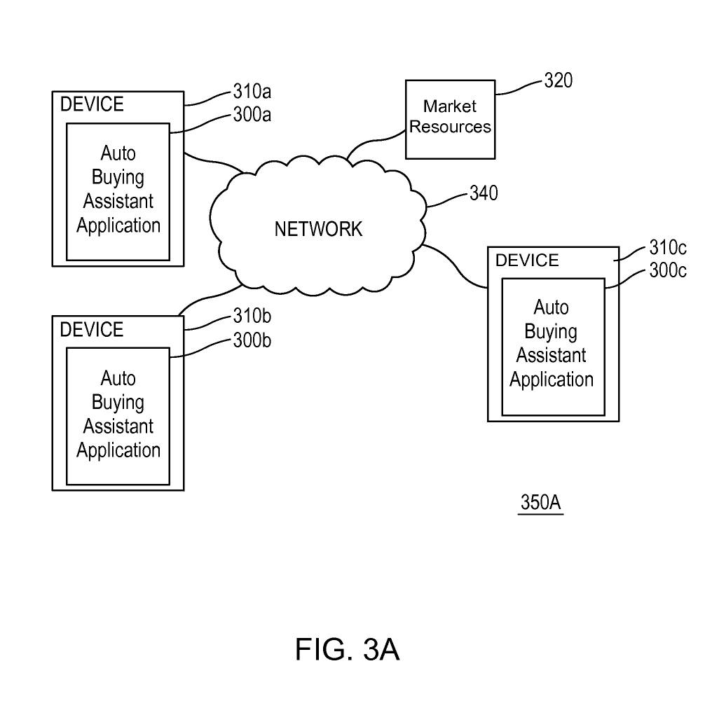

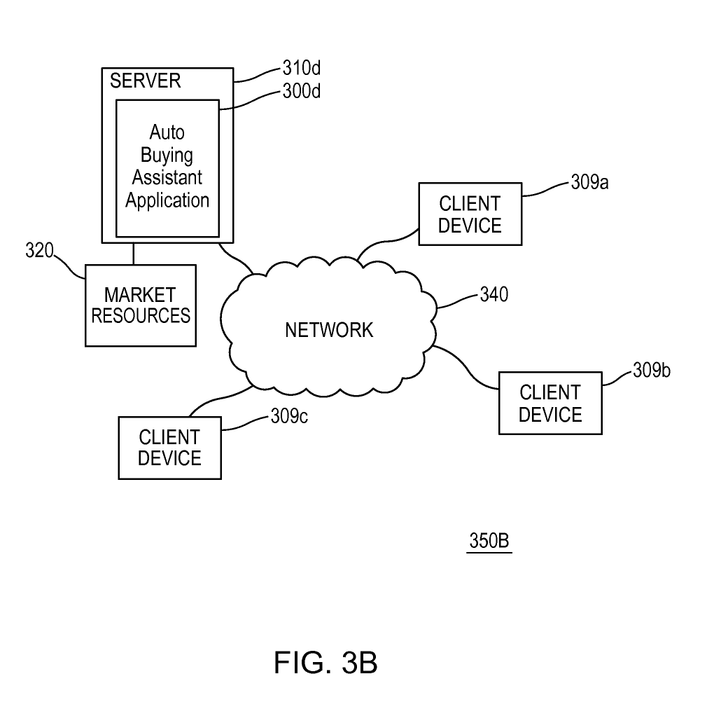

The transaction module 208 includes program code for connecting the auto buying assistant application 200B to a financial databases, insurance databases, and auto-dealership databases such that money and title can be appropriately exchanged. Further, title exchange and vehicle registration are also implemented by the transaction module 208. In addition, confirmations are generated and forwarded by the transaction module 208 to all the contracting parties, such that the new owner may drive their insured vehicle off the lot. Note, each above describe module and its functionality is further described in connection with FIGS. 3-5 below.

FIGS. 3A-B are block diagrams illustrating examples of systems in which an auto buying assistant application operates. Specifically, FIG. 3 is block diagram illustrating an example of a system 350A in which the auto buying assistant applications 300a-c operate. FIG. 3A further illustrates several devices 310a-c, each having the auto buying assistant applications 300a-c installed thereon (see also FIG. 2A-B). The devices 310a-c are preferably smartphones, but may alternatively be any of the computer systems described above. Similarly, the network 340 over which the devices 310a-c (through their interfaces, which are not shown) communicate preferably is a cellular network; however, it may alternatively be any conventional networking technology. For instance, the network may be any of the technologies of cellular, global area network, wireless local area networks, wide area networks, local area networks, or combinations thereof, but is not limited to. Further, the interfaces of the devices 310a-c may be any interface suited for input and output of communication data, whether that communication is visual, auditory, electrical, transitive, or the like.

FIG. 3B is an illustrated alternative where client devices 309a-c may respectively access a device 310d (see also FIG. 2A-B), preferably through direct application linking, with the device 310d providing the auto buying assistant application 300d for access by the client devices 309a-c. In this embodiment, the device 310d is preferably a server providing application access to and computing power for use by client devices 309a-c (i.e. smartphones). This would reduce the resource requirements on the client side and enhance efficiency of the system 350B. However, as another alternative, the functionality of the auto buying assistant application 300d may be divided between the client devices 309a-c and the device 310d, where either function may be located separately on either device and accessed through distributed computing, such that the functionality is provided for, shared, and relied upon by other devices. Finally, of course, a single computing device may be independently configured to include the entire functionality of the auto buying assistant application 300d.

Additionally, as illustrated in FIGS. 3A-B market resources 320 are shown as a singular block in the figure, but it should be understood that the singular block represents a variety of resources, including financial intuition databases, automobile data resources, or resources compiled by an information services provider. Further, market resources 320 are typically accessed externally for use by the application, since the amount of property data is rather voluminous, and since the application is configured to allow access to multiple loan databases and multiple auto resource databases. The application accesses and retrieves the market data from these resources in support of dynamically providing location-based promotion for instantaneous assistance in vehicle and insurance procurement.

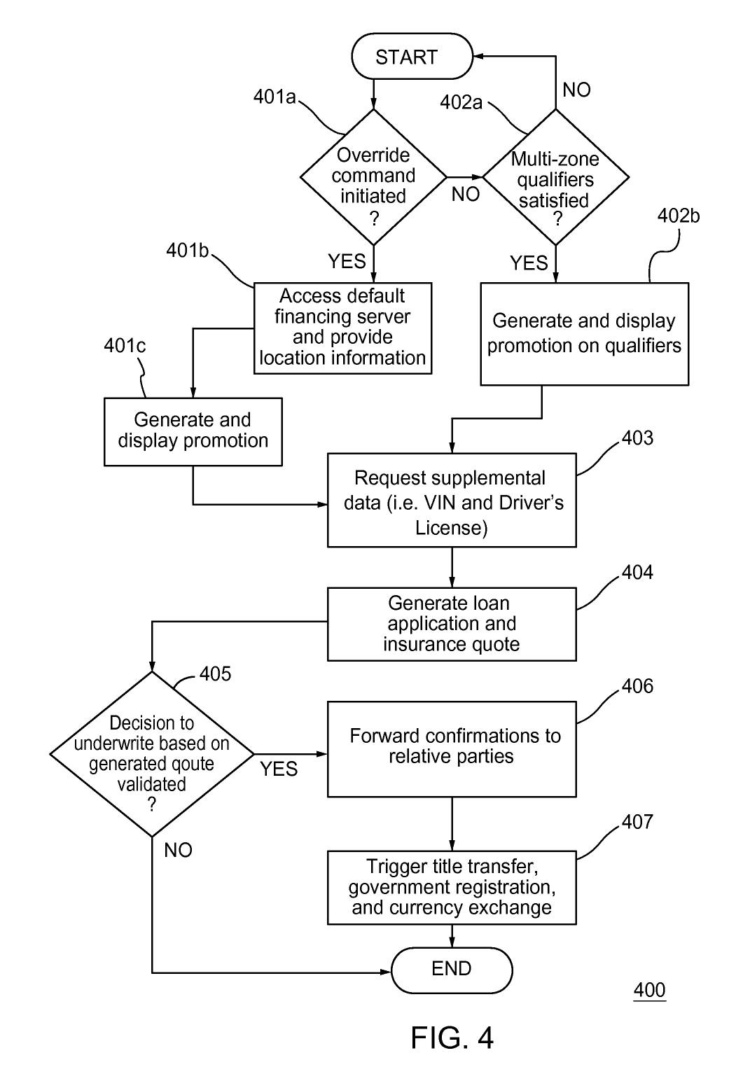

FIG. 4 is a flow diagram illustrating an example of an auto buying assistant process. Specifically, FIG. 4 is a flow diagram illustrating an example of the auto buying assistant process 400 that describes one possible operation sequence for the applications 200A and 200B.

Specifically, the auto buying assistant process 400 begins with a loop of checking whether an override command has been initiated 401a or whether multi-zone qualifiers have been satisfied 402a. If either of these states are satisfied, the process progresses towards requesting 403 supplemental data. When an override command is detected 401a, the process simultaneously accesses 401b the relative financing database to retrieve financing information based on the current location information. Then, the process 400 generates and displays 401c the promotion. The promotion that is generated and displayed 401c may be any of the types of messages discussed above. After the promotion generation, the process progresses towards requesting 403 supplemental data.

When the override command is not initiated, the process continues to monitor whether the multi-zone qualifiers have been satisfied 402a. The satisfiers at least include a length of time and a location. A preferred length of time would be greater than three minutes to avoid the scenario when a mobile phone is in a driver's pocket that is temporarily stopped at a traffic light that is within a dealerships radial zone. More appropriately, setting the length of time to ten minutes will prevent the display of a promotion in the case when a driver temporarily stops at an auto dealership to view a vehicle and quickly decides that they are not interested. In addition, the GPS accuracy or, alternatively, image metadata association is checked. When the multi-zone qualifiers have been satisfied 402a, the process progresses towards requesting 403 supplemental data. Prior to requesting 403 supplemental data, the qualifiers are used to generate and display 402b a promotion based on the qualifiers (specifically, the mobile phone's lovation). When the process 400 generates a promotion based on an override request 401a or based on qualifiers 402, the process 400 may either internally or externally generate the promotion, as described above, using resources stored internally or externally.

The process 400 requests 403 supplemental data after it displays any promotion. This in general is a request for at least a name and address of the mobile phone user, financial institution member, or potential borrower. It is preferable that a driver's license and the VIN are supplied, because, in general, the more information given to the process 400 prior to generating 404 the loan application or updating the promotion, the more accurate the loan application or updated loan promotion will be.

Next, the supplemental data is next used to generate 404 user or location specific loan application and insurance quotes. If it is deemed that the generated loan application or updated promotion is agreeable, the process 400 may then confirm or validate 405 the decision to use the generated loan application or updated promotion. In other words, if a user wants to use the location-based promotion and connected loan application, the user must confirm their choice such that the transaction may proceed. When the decision 405 to underwrite based on the generated quote is validated, confirmations are then forwarded 406 to all relative parties. After the agreement is confirmed 406, title transfer and vehicle registration are triggered 406. In addition, the appropriate parties also receive confirmation of money transfer. If the decision 405 to underwrite based on the generated quote is not validated, the process 400 ends (or returns to START).

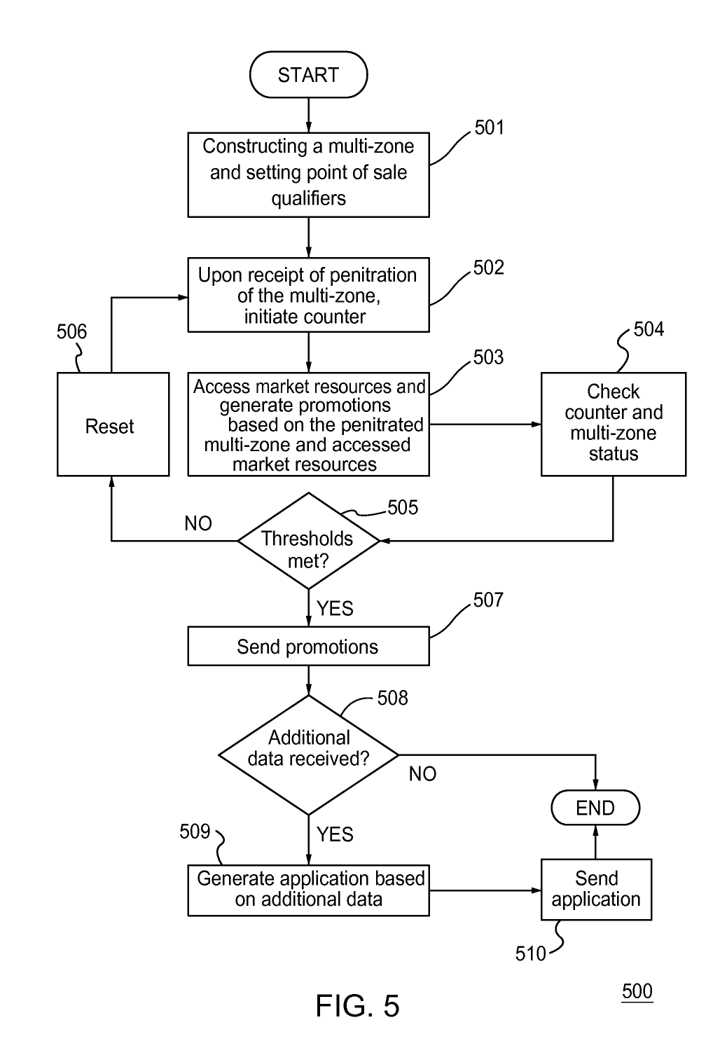

FIG. 5 is a flow diagram illustrating an example of an auto buying assistant process. Specifically, FIG. 5 is a flow diagram illustrating an example of the auto buying assistant process 500 that describes one possible operation sequence for the applications 200A and 200B.

Specifically, the auto buying assistant process 500 begins with the construction 501 of zones over a geographic area and setting the point of sale qualifiers. Upon detection of zone penetration, a timer is initiated 502 to count for a pre-determined time. While the timer is counting, promotions are generated 503 based on the received multi-zone data and market resource data (both of which may be internally in the application 200A-B). The counter and multi-zone status are then checked 504, and if the default thresholds are met 505 then the promotion are sent 507. For example, the application 200A-B may after a pre-determined elapsed time determine if the smartphone is within a sub-zone. Alternatively, the application 200A-B by may calculate the time between when a primary zone was penetrated to the time stamps of an image and check to see if this time gap is greater than the pre-determined elapsed time. If the default thresholds are not met 505 then the counter is reset 506 and the process 500 returns to detecting multi-zone penetration 502. After the promotions are sent 507, the process checks to see if additional data is received. When additional data is not received 508, the process ends. In this case, it is assumed that the user does not want to take advantage of the promotions. If additional data is received 508, the user must have decided to further investigate purchasing the vehicle. Thus, the process 500 generates 509 an application or updated promotion based on the additional data. Finally, the generated application is sent to the user 510. It should be noted that a preferred embodiment applies the auto buying assistant application to auto loan promotions and product; however, this application may be provided in other purchasing contexts.7

Thus, embodiments of the described produce and provide methods and apparatus for a model for providing real-time location-based promotions to a buyer without the need for additional post-purchase decision conversations and signing ceremonies. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for automatic generation of financing criteria by a mobile device including a location determination technology and a camera, comprising:
acquiring location information from the location determination technology;
determining a presence of location conditions that include a physical residence of the mobile device within a zone;
presenting a promotion and a set of information requests that include an applicant identification information request and an automobile identification information request if the presence of location conditions are determined; and
presenting an updated promotion that is based upon a combination of the promotion, the applicant identification information, and the automobile identification information.

2. The method of claim 1, wherein determining the presence of location conditions:
identifying when the location determination technology determines that the mobile device enters the zone, and
identifying when the mobile device remains in the zone for a predetermined period of time following entry in the zone.

3. The method of claim 2, wherein the pre-determined time is greater than three minutes.

4. The method of claim 2, wherein the pre-determined time is ten minutes.

5. The method of claim 1, further comprising:
generating an override command that requests immediate receipt of the promotion without requiring the presence of the location conditions.

6. The method of claim 1, wherein the zone is a boundary of an auto dealership.

7. The method of claim 1, wherein the zone is a radial boundary around a GPS location.

8. The method of claim 1, wherein the zone is a multi-zone structure that includes a primary zone and sub-zones that are smaller than the primary zone.

9. The method of claim 8, wherein the primary zone is a boundary of an auto dealership and the sub-zones are relative to each vehicle within an auto dealership.

10. The method of claim 8, wherein the promotion differs depending upon the sub-zone in which the mobile device resides.

11. The method of claim 1, wherein the camera images an applicant identification and an automobile vehicle identification number to retrieve the applicant identification information and the automobile identification information prior to replying to the set of information requests.

12. The method of claim 11, wherein the applicant identification is a driver license, and
wherein imaging the driver license includes scanning a driver's license bar code and extracting name and address information.

13. The method of claim 11, wherein imaging the automobile vehicle identification number includes decoding an image of a VIN plate to extract alphanumeric characters.

14. The method of claim 1, further comprising:
confirming acceptance of the updated promotion.

15. The method of claim 14, wherein the updated promotion is an auto loan application and wherein confirming acceptance of the auto loan application includes processing the loan application to complete a vehicle purchase.

16. A computer program product stored on a non-transitory computer readable medium that when executed by a computer performs a method for automatic generation of financing criteria by a mobile device including a location determination technology and a camera, the method comprising:
acquiring location information from the location determination technology;
determining a presence of location conditions that include a physical residence of the mobile device within a zone;
presenting a promotion and a set of information requests that include an applicant identification information request and an automobile identification information request if the presence of location conditions are determined;
presenting an updated promotion that is a combination of the promotion, the applicant identification information, and the automobile identification information.

17. A system for automatic generation of financing criteria by a mobile device including a location determination technology and a camera, comprising:
a means for acquiring location information from the location determination technology;
a means for determining a presence of location conditions that include a physical residence of the mobile device within a zone;
a means for presenting a promotion and a set of information requests that include an applicant identification information request and an automobile identification information request if the presence of location conditions are determined; and
a means for presenting an updated promotion that is a combination of the promotion, the applicant identification information, and the automobile identification information.

18. A method for automatic initiation of financing criteria by an electronic device, comprising:
detecting whether the a mobile device is located within a first zone;
generating a promotion based on legal authorities relative to the first zone, a user profile associated with the mobile device, real-time market values, and a financial institution; and
sending the promotion to be displayed by the mobile device only if the mobile device is located within a second zone after a pre-determined elapsed time, the second zone being within the first zone.

19. The method of claim 18, wherein determining that the mobile device is located within the second zone includes checking that the total time between when the mobile device is detected within the first zone and a time information from an image received from the mobile device is greater than the pre-determined elapsed time.

20. The method of claim 18, wherein real-time market values include current interest rates.
